(19) United States
(12) Patent Application Publication
(10) Pub. No.: US 2026/0086404 A1
(43) Pub. Date: Mar. 26, 2026

(54) Display with Multiple Operating Modes

(71) Applicant: Apple Inc., Cupertino, CA (US)

(72) Inventors: Guanjun Tan, Campbell, CA (US); Andrew Lin, San Jose, CA (US); Lingtao Wang, Cupertino, CA (US); Michael Slootsky, Santa Clara, CA (US); Cheuk Chi Lo, Belmont, CA (US); Enkhamgalan Dorjgotov, Sunnyvale, CA (US); Luya Zhang, Sunnyvale, CA (US); Fangwang Gou, San Jose, CA (US); Shengchang Cai, Belmont, CA (US); Sheng Zhang, Saratoga, CA (US)

(21) Appl. No.: 19/303,198

(22) Filed: Aug. 18, 2025

Related U.S. Application Data
(60) Provisional application No. 63/697,259, filed on Sep. 20, 2024.

(51) Int. Cl. G02F 1/1335; G02B 27/00; G02F 1/13363

(52) U.S. Cl. CPC G02F 1/133528; G02B 27/0093; G02F 1/133526; G02F 1/13363

(57) ABSTRACT

An electronic device may have a display panel. Light from the display panel may be focused by a lens assembly towards a viewer. A linear polarizer, liquid crystal cell, quarter wave plate, and geometric phase grating may be interposed between the display panel and the lens assembly. The display may be operable in multiple operating modes. In a high resolution operating mode, the liquid crystal cell may switch between first and second states. In a high refresh rate operating mode, the liquid crystal cell may operate in a third state. The display resolution may be twice as high in the high resolution operating mode than in the high refresh rate operating mode. The display refresh rate may be twice as high in the high refresh rate operating mode than in the high resolution operating mode.

This application claims the benefit of U.S. provisional patent application No. 63/697,259, filed Sep. 20, 2024, which is hereby incorporated by reference herein in its entirety.

### BACKGROUND

This relates generally to electronic devices, including to electronic devices with displays.

Electronic devices often include displays. For example, an electronic device may have a liquid crystal display (LCD) based on liquid crystal display pixels or an organic light-emitting diode (OLED) display based on organic light-emitting diode pixels. Head-mounted displays such as virtual reality glasses use lenses. If care is not taken, head-mounted displays may have lower resolution or lower refresh rate than desired.

### SUMMARY

An electronic device may include a display and one or more lens elements through which the display is viewable. The display may include a display panel comprising an array of display pixels, a liquid crystal cell configured to selectively rotate a polarization of incident light, and a geometric phase grating interposed between the display panel and the liquid crystal cell. The display may be operable in a first operating mode where the display has a first resolution and a first refresh rate, the display may be operable in a second operating mode where the display has a second resolution and a second refresh rate, the second resolution may be double the first resolution, and the second refresh rate may be half the first refresh rate.

An electronic device may include a display panel comprising an array of display pixels, a liquid crystal cell configured to selectively rotate a polarization of light from the array of display pixels, a geometric phase grating that is interposed between the display panel and the liquid crystal cell, a quarter wave plate that is interposed between the geometric phase grating and the liquid crystal cell, and a linear polarizer. The liquid crystal cell may be interposed between the quarter wave plate and the linear polarizer.

A display may include an array of display pixels and light redirecting layer that is configured to, in response to receiving an input beam of light, output a first output beam of light having a first polarization and a second output beam of light having a second polarization that is opposite the first polarization. The first output beam of light may be redirected in a first direction relative to the input beam of light, the second output beam of light may be redirected in a second direction relative to the input beam of light, and the second direction may be different than the first direction. The display may also include a liquid crystal cell operable in first, second, and third states and a linear polarizer. The liquid crystal cell may be interposed between the liquid crystal cell and the linear polarizer, the linear polarizer may pass more than 90% of the first output beam and less than 10% of the second output beam while the liquid crystal cell operates in the first state, the linear polarizer may pass less than 10% of the first output beam and more than 90% of the second output beam while the liquid crystal cell operates in the second state, and wherein the linear polarizer may pass between 40% and 60% of the first output beam and between 40% and 60% of the second output beam while the liquid crystal cell operates in the third state.

A method of operating a display comprising physical pixels may include operating the display in a first mode and operating the display in a second mode. Each physical pixel may have first and second corresponding virtual pixels with different footprints. In the first mode, the display may have a first effective resolution, the display may have a first effective refresh rate, and the first and second virtual pixels may have the same luminance magnitudes for each physical pixel in the array of physical pixels. In the second mode, the display may have a second effective resolution that is double the first effective resolution, the display may have a second effective refresh rate that is half the first effective refresh rate, and the first and second virtual pixels may have different luminance magnitudes for at least some of the physical pixels.

### BRIEF DESCRIPTION OF THE DRAWINGS

FIG. 1 is a schematic diagram of an illustrative electronic device having a display in accordance with some embodiments.

FIG. 2 is a schematic diagram of an illustrative display in accordance with some embodiments.

FIG. 3 is a cross-sectional side view of an illustrative electronic device having a display and a lens assembly in accordance with some embodiments.

FIG. 4 is a top view of an illustrative geometric phase grating in accordance with some embodiments.

FIG. 5 is a cross-sectional side view of an illustrative geometric phase grating in accordance with some embodiments.

FIG. 6A is a schematic diagram of the illustrative display of FIG. 3 while the liquid crystal cell is in a first state in accordance with some embodiments.

FIG. 6B is a top view of an illustrative display pixel while the liquid crystal cell is in the first state in accordance with some embodiments.

FIG. 7A is a schematic diagram of the illustrative display of FIG. 3 while the liquid crystal cell is in a second state in accordance with some embodiments.

FIG. 7B is a top view of an illustrative display pixel while the liquid crystal cell is in the second state in accordance with some embodiments.

FIG. 8A is a schematic diagram of the illustrative display of FIG. 3 while the liquid crystal cell is in a third state in accordance with some embodiments.

FIG. 8B is a top view of an illustrative display pixel while the liquid crystal cell is in the third state in accordance with some embodiments.

FIG. 9 is a timing diagram showing illustrative operations of the display of FIG. 3 in different operating modes in accordance with some embodiments.

FIGS. 10A and 10B are top views of an illustrative liquid crystal cell with independently controllable portions in accordance with some embodiments.

FIG. 11 is a flowchart of an illustrative method of controlling a display in accordance with some embodiments.

FIG. 12 is a diagram showing different sampling locations for different frames while some of the content on the display is moving in accordance with some embodiments.

FIG. 13 is a top view of an illustrative display showing sampling locations for a physical pixel in accordance with some embodiments.

FIG. 14 is a diagram of illustrative control circuitry for a display that performs dithering to mitigate a shimmer artifact in accordance with some embodiments.

### DETAILED DESCRIPTION

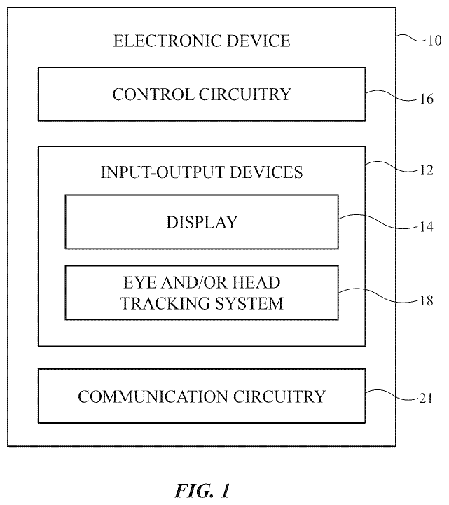

An illustrative electronic device of the type that may be provided with a display is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a display, a computer display that contains an embedded computer, a computer display that does not contain an embedded computer, a gaming device, a navigation device, an embedded system such as a system in which electronic equipment with a display is mounted in a kiosk or automobile, or other electronic equipment. Electronic device 10 may have the shape of a pair of eyeglasses (e.g., supporting frames), may form a housing having a helmet shape, or may have other configurations to help in mounting and securing the components of one or more displays on the head or near the eye of a user. As examples, electronic device 10 may be an augmented reality (AR) headset and/or virtual reality (VR) headset.

As shown in FIG. 1, electronic device 10 may include control circuitry 16 for supporting the operation of device 10. The control circuitry may include storage such as hard disk drive storage, nonvolatile memory (e.g., flash memory or other electrically-programmable-read-only memory configured to form a solid-state drive), volatile memory (e.g., static or dynamic random-access memory), etc. Processing circuitry in control circuitry 16 may be used to control the operation of device 10. The processing circuitry may be based on one or more microprocessors, microcontrollers, digital signal processors, baseband processors, power management units, audio chips, application specific integrated circuits, etc.

Input-output circuitry in device 10 such as input-output devices 12 may be used to allow data to be supplied to device 10 and to allow data to be provided from device 10 to external devices. Input-output devices 12 may include buttons, joysticks, scrolling wheels, touch pads, keypads, keyboards, microphones, speakers, tone generators, vibrators, cameras, sensors, light-emitting diodes and other status indicators, data ports, etc. A user can control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements. A touch sensor for display 14 may be formed from electrodes formed on a common display substrate with the pixels of display 14 or may be formed from a separate touch sensor panel that overlaps the pixels of display 14. If desired, display 14 may be insensitive to touch (i.e., the touch sensor may be omitted). Display 14 in electronic device 10 may be a head-up display that can be viewed without requiring users to look away from a typical viewpoint or may be a head-mounted display that is incorporated into a device that is worn on a user's head. If desired, display 14 may also be a holographic display used to display holograms.

Control circuitry 16 may be used to run software on device 10 such as operating system code and applications. During operation of device 10, the software running on control circuitry 16 may display images on display 14.

Device 10 may include cameras and other components that form part of eye and/or head tracking system 18. The camera(s) or other components of system 18 may face an expected location for a viewer and may track the viewer's eyes and/or head (e.g., images and other information captured by system 18 may be analyzed by control circuitry 16 to determine the location of the viewer's eyes and/or head). Eye and/or head tracking system 18 may include any desired number/combination of infrared and/or visible light detectors. Eye and/or head tracking system 18 may optionally include light emitters to illuminate the scene.

In addition to determining the position of the viewer's eyes, eye and/or head tracking system 18 may determine the gaze direction of the viewer's eyes. Eye and/or head tracking system 18 may include a camera and/or other gaze-tracking system components (e.g., light sources that emit beams of light so that reflections of the beams from a user's eyes may be detected) to monitor the user's eyes. One or more gaze-tracker(s) in system 18 may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or may determine other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze.

The example of using an optical component (e.g., camera or image sensor) in the eye and/or head tracking system 18 is merely illustrative. If desired information from one or more additional (non-optical) components may also or instead be used in eye and/or head tracking system 18.

To support communications between device 10 and external equipment, control circuitry 16 may communicate using communications circuitry 21. Circuitry 21 may include antennas, radio-frequency transceiver circuitry, and other wireless communications circuitry and/or wired communications circuitry. Circuitry 21, which may sometimes be referred to as control circuitry and/or control and communications circuitry, may support bidirectional wireless communications between device 10 and external equipment over a wireless link (e.g., circuitry 21 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link). Wireless communications may, for example, be supported over a Bluetooth® link, a WiFi® link, a 60 GHz link or other millimeter wave link, a cellular telephone link, or other wireless communications link. Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

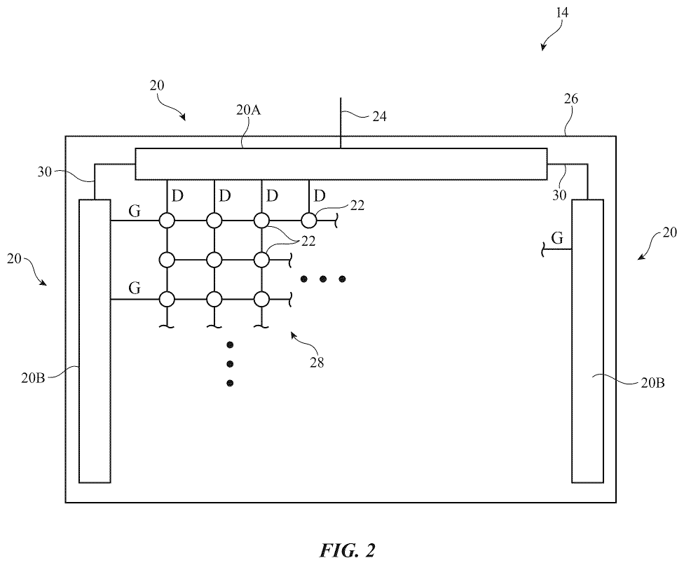

FIG. 2 is a diagram of an illustrative display. As shown in FIG. 2, display 14 may include layers such as substrate layer 26. Substrate layers such as layer 26 may be formed from rectangular planar layers of material or layers of material with other shapes (e.g., circular shapes or other shapes with one or more curved and/or straight edges). The substrate layers of display 14 may include glass layers, polymer layers, silicon layers, composite films that include polymer and inorganic materials, metallic foils, etc.

Display 14 may have an array of pixels 22 for displaying images for a user such as pixel array 28. Pixels 22 in array 28 may be arranged in rows and columns. The edges of array 28 may be straight or curved (i.e., each row of pixels 22 and/or each column of pixels 22 in array 28 may have the same length or may have a different length). There may be any suitable number of rows and columns in array 28 (e.g., ten or more, one hundred or more, or one thousand or more, etc.). Display 14 may include pixels 22 of different colors. As an example, display 14 may include red pixels, green pixels, and blue pixels.

Display driver circuitry 20 may be used to control the operation of pixels 28. Display driver circuitry 20 may be formed from integrated circuits, thin-film transistor circuits, and/or other suitable circuitry. Illustrative display driver circuitry 20 of FIG. 2 includes display driver circuitry 20A and additional display driver circuitry such as gate driver circuitry 20B. Gate driver circuitry 20B may be formed along one or more edges of display 14. For example, gate driver circuitry 20B may be arranged along the left and right sides of display 14 as shown in FIG. 2.

As shown in FIG. 2, display driver circuitry 20A (e.g., one or more display driver integrated circuits, thin-film transistor circuitry, etc.) may contain communications circuitry for communicating with system control circuitry over signal path 24. Path 24 may be formed from traces on a flexible printed circuit or other cable. The control circuitry may be located on one or more printed circuits in electronic device 10. During operation, control circuitry (e.g., control circuitry 16 of FIG. 1) may supply circuitry such as a display driver integrated circuit in circuitry 20 with image data for images to be displayed on display 14. Display driver circuitry 20A of FIG. 2 is located at the top of display 14. This is merely illustrative. Display driver circuitry 20A may be located at both the top and bottom of display 14 or in other portions of device 10.

To display the images on pixels 22, display driver circuitry 20A may supply corresponding image data to data lines D while issuing control signals to supporting display driver circuitry such as gate driver circuitry 20B over signal paths 30. With the illustrative arrangement of FIG. 2, data lines D run vertically through display 14 and are associated with respective columns of pixels 22.

Gate driver circuitry 20B (sometimes referred to as gate line driver circuitry or horizontal control signal circuitry) may be implemented using one or more integrated circuits and/or may be implemented using thin-film transistor circuitry on substrate 26. Horizontal control lines G (sometimes referred to as gate lines, scan lines, emission control lines, etc.) run horizontally through display 14. Each gate line G is associated with a respective row of pixels 22. If desired, there may be multiple horizontal control lines such as gate lines G associated with each row of pixels. Individually controlled and/or global signal paths in display 14 may also be used to distribute other signals (e.g., power supply signals, etc.).

Gate driver circuitry 20B may assert control signals on the gate lines G in display 14. For example, gate driver circuitry 20B may receive clock signals and other control signals from circuitry 20A on paths 30 and may, in response to the received signals, assert a gate line signal on gate lines G in sequence, starting with the gate line signal G in the first row of pixels 22 in array 28. As each gate line is asserted, data from data lines D may be loaded into a corresponding row of pixels. In this way, control circuitry such as display driver circuitry 20A and 20B may provide pixels 22 with signals that direct pixels 22 to display a desired image on display 14. Each pixel 22 may have a light-emitting diode and circuitry (e.g., thin-film circuitry on substrate 26) that responds to the control and data signals from display driver circuitry 20.

Gate driver circuitry 20B may include blocks of gate driver circuitry such as gate driver row blocks. Each gate driver row block may include circuitry such output buffers and other output driver circuitry, register circuits (e.g., registers that can be chained together to form a shift register), and signal lines, power lines, and other interconnects. Each gate driver row block may supply one or more gate signals to one or more respective gate lines in a corresponding row of the pixels of the array of pixels in the active area of display 14.

Display 14 for device 10 may be a liquid crystal display, an organic light-emitting diode display, an electrophoretic display, a plasma display, an electrowetting display, a display formed using other display technologies, or a display that uses two or more of these display technologies in a hybrid configuration.

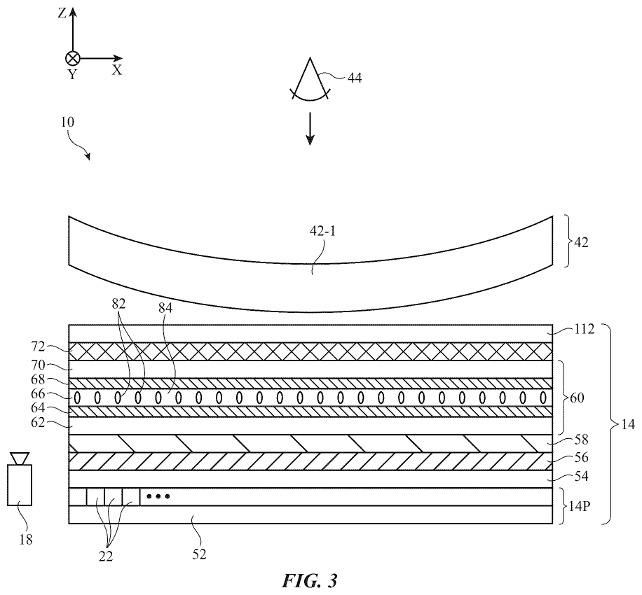

FIG. 3 is cross-sectional side view of an illustrative electronic device that includes a display and one or more lens elements. As shown in FIG. 3, lens assembly 42 (sometimes referred to as lens module 42, lens 42, lens(es) 42, etc.) is included in device 10 in addition to display 14. The lens assembly may optionally be a catadioptric lens assembly (e.g., a lens assembly that both reflects and refracts incident light). The lens assembly may include one or more lens elements such as lens element 42-1. Lens assembly 42 may focus light towards viewer 44 (who may view the display in the negative Z-direction in FIG. 3).

There are many possible arrangements for lens assembly 42. In general, the lens assembly may include one lens element, two lens elements, three elements, more than three elements, etc. Each lens element may have any desired combination of convex surfaces and concave surfaces. The convex and concave surfaces may be spherical, aspherical, cylindrical, or have any other desired curvature. The lens assembly may include other optical layers such as one or more linear polarizers, one or more quarter waveplates, one or more partial mirrors, one or more reflective polarizers, etc.

As previously mentioned, lens assembly 42 may be a catadioptric lens assembly. However, this need not be the case. The lens assembly may instead be a refractive lens assembly, may use one or more Fresnel lenses, etc.

As shown in FIG. 3, display 14 may include a display panel 14P. Display panel 14P may include an array of display pixels 22 similar to as shown in FIG. 2. The display panel may be an organic light-emitting diode display panel, a liquid crystal display panel, or a display panel including pixels formed from any other desired type of display technology. The array of display pixels 22 may be formed on a backplane such as silicon backplane 52. This example is merely illustrative and in general the array of pixels may include any desired type of backplane. Display panel 14P may emit light in the positive Z-direction in FIG. 3 (e.g., towards lens assembly 42). Glass layer 54 (sometimes referred to as encapsulation glass 54, cover glass 54, etc.) may be formed over display panel 14P. Glass layer 54 may sometimes be considered part of display panel 14P.

As shown in FIG. 3, eye and/or head tracking system 18 may be included adjacent to display 14 and may capture images of viewer 44 during operation of device 10. The images captured by the eye and/or head tracking system 18 may determine the direction of a user's point of gaze relative to display 14.

To improve the user experience for viewer 44, display 14 may be operable in multiple operating modes such as a first operating mode and a second operating mode. The first operating mode may have a higher resolution (i.e., the number of pixels per unit area) and a lower refresh rate (i.e., the number of times per second the image on the display updates) than the second operating mode. The first operating mode may therefore sometimes be referred to as the high resolution operating mode, high resolution mode, first mode, etc. The second operating mode may sometimes be referred to as the high refresh rate operating mode, high refresh rate mode, second mode, etc.

Control circuitry 16 may select the operating mode for display 14 based on the type of content being displayed and/or gaze information associated with viewer 44. When the content on display 14 is static, the user may be more sensitive to display resolution than display refresh rate. In these types of scenarios, the display may therefore operate in the high resolution operating mode where resolution is prioritized over refresh rate. When the content on display 14 is moving, the user may be more sensitive to display refresh rate than display resolution. In these types of scenarios, the display may therefore operate in the high refresh rate operating mode where refresh rate is prioritized over resolution.

Display 14 may therefore operate in the high refresh rate operating mode when video content is presented on the display. When static content is presented on the display, the display may operate in either the high refresh rate operating mode or the high resolution operating mode depending on the user's gaze. When the user's direction of gaze is static while viewing static content, the user may be more sensitive to display resolution than display refresh rate. In these types of scenarios, the display may therefore operate in the high resolution operating mode where resolution is prioritized over refresh rate. When the user's direction of gaze is moving while viewing static content, the user may be more sensitive to display refresh rate than display resolution. In these types of scenarios, the display may therefore operate in the high refresh rate operating mode where refresh rate is prioritized over resolution.

To allow display 14 to switch between multiple operating modes, the display may include a light redirecting layer and a liquid crystal cell in addition to display panel 14P. As shown in FIG. 3, light redirecting layer 56 is formed over encapsulation glass 54. Liquid crystal cell 60 is formed over light redirecting layer 56. A wave plate 58 is interposed between light redirecting layer 56 and liquid crystal cell 60. Wave plate 58 may be a quarter wave plate and may sometimes be referred to as quarter wave plate 58, retarder 58, etc. A linear polarizer 72 is formed over liquid crystal cell 60. Light redirecting layer 56 is therefore interposed between display panel 14P and liquid crystal cell 60. Liquid crystal cell 60 is therefore interposed between light redirecting layer 56 and linear polarizer 72.

One or more additional layers such as layer 112 may optionally be formed over linear polarizer 72. Layer(s) 112 may be interposed between linear polarizer 72 and lens assembly 42. The one or more additional layers 112 may include a quarter wave plate, a half wave plate, a positive C-plate, an antireflective coating (ARC), or any other desired layer.

As one example, light redirecting layer 56 may be a diffractive-type flat redirecting layer. The diffractive-type flat redirecting layer may be a geometric phase grating. A geometric phase grating is a diffractive-type optical layer based on geometric phase. The geometric phase grating may be achieved using liquid crystal. To form the geometric phase grating, a flat liquid crystal film may be formed on a transparent substrate (e.g., glass, plastic, etc.). The liquid crystal film may include three-dimensional patterns of liquid crystals. The liquid crystals may manipulate the polarization of optical beams passing through the liquid crystals, which modulates the geometric phase of the optical beam. The geometric phase may be modulated in a spatially varying fashion to provide desired light redirecting effects. A geometric phase grating may redirect light using polarization-dependent diffraction and therefore may be considered a diffractive-type light redirecting layer.

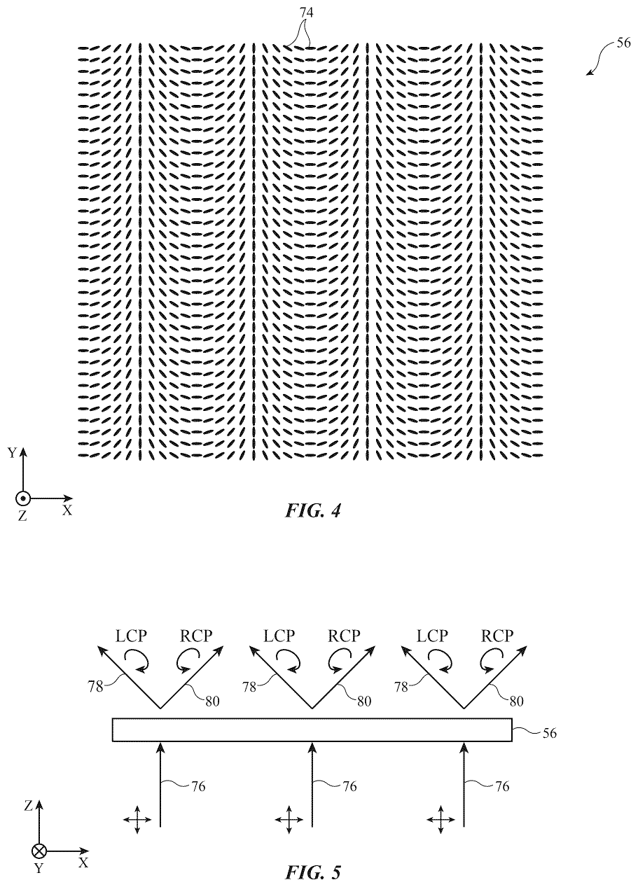

FIG. 4 is a top view of an illustrative geometric phase grating 56 that may be used in the electronic device of FIG. 3. As shown in FIG. 4, the geometric phase grating 56 may include liquid crystals 74 with different orientations. There may be multiple layers of liquid crystals in the geometric phase grating (e.g., stacked along the Z-axis). The liquid crystals may be formed on a transparent substrate with an intervening alignment film. An additional transparent substrate may optionally be formed over the liquid crystal film in the geometric phase grating.

FIG. 5 is a cross-sectional side view of an illustrative geometric phase grating showing how the geometric phase grating may redirect light. Incident light 76 (sometimes referred to as input beam 76) may be parallel to the surface normal of geometric phase grating 56. Geometric phase grating 56 receives the input beam and outputs two corresponding output beams. First output beam 78 is lefthand circularly polarized (LCP) and is redirected in the negative X-direction (relative to the input beam). Second output light 80 is righthand circularly polarized (RCP) and is redirected in the positive X-direction (relative to the input beam). Geometric phase grating 56 therefore splits an input beam of unpolarized light into two output beams of opposite circularly polarized light. The two output beams are redirected by the same magnitude but in different directions. The output beams may be symmetric about an axis parallel to the input beam. The output beams may be referred to as being redirected in opposite directions. As a specific example, one output beam may be redirected by positive 20 degrees whereas one output beam may be redirected by negative 20 degrees. As shown in FIG. 5, the magnitude of the redirection of light by geometric phase grating 56 is uniform across the footprint of geometric phase grating 56.

The example in FIGS. 4 and 5 of light redirecting layer 56 being a geometric phase grating is merely illustrative. In general, light redirecting layer 56 may be any desired type of light redirecting layer. Instead of or in addition to comprising a geometric phase grating, light redirecting layer 56 may comprise biaxial crystal, a metasurface, etc.

Liquid crystal cell 60 may include a first substrate 62, a first electrode 64, a liquid crystal layer 66, a second electrode 68, and a second substrate 70. Substrates 62 and 70 may be referred to as transparent substrates, transparent layers, etc. Each one of substrates 62 and 70 may be formed from glass or polymer (e.g., polyethylene terephthalate). Substrates 62 and 70 may be formed from the same material or from different materials. Substrates 62 and 70 may be sufficiently flexible to be bent.

Each substrate has a corresponding electrode layer. Electrode layer 64 is formed on substrate 62 and electrode layer 68 is formed on substrate 70. Electrode layers 64 and 68 (sometimes referred to as conductors 64 and 68, conductive layers 64 and 68, conductive electrodes 64 and 68, etc.) may be used to selectively apply a voltage across liquid crystal layer 66. Electrode layers 64 and 68 may be formed from a transparent conductive material such as indium tin oxide (ITO) or any other desired material.

Liquid crystal layer 66 includes liquid crystals 82 distributed in host material 84. Host material 84 (sometimes referred to as interstitial material 40) may be formed from polymer or any other desired material.

Liquid crystals 82 of the liquid crystal layer are birefringent. The liquid crystals in the liquid crystal layer may be aligned in a desired orientation in the absence of an applied voltage. For example, in FIG. 3 the liquid crystals have an elongated shape (extending along an axis) that extends parallel to the Z-axis (e.g., orthogonal to the plane in which display 14 is formed). A voltage may selectively be applied across the liquid crystal layer using electrode layers 64 and 68. Control circuitry within electronic device 10 (e.g., control circuitry 16) may control the voltage applied to electrode layers 64 and 68. When no voltage is applied across liquid crystal layer 60 (as in FIG. 3), the liquid crystals extend parallel to the Z-axis. When a sufficiently high voltage is applied across liquid crystal layer 66, the liquid crystals rotate relative to FIG. 3 and extend parallel to the X-axis (e.g., parallel to the plane in which display 14 is formed). An intermediate voltage may be applied across liquid crystal layer 66 to cause the liquid crystals to be at a non-parallel, non-orthogonal, angle relative to the X-axis and the Z-axis. The example of the liquid crystals extending parallel to the Z-axis in the absence of an applied voltage is merely illustrative. If desired, the liquid crystals may extend parallel to the X-axis in the absence of an applied voltage.

Liquid crystal cell 60 may use electronically controlled birefringence (ECB) liquid crystal technology, vertical alignment liquid crystal technology, homogenous alignment liquid crystal technology, twisted nematic liquid crystal technology, ferroelectric liquid crystal technology, etc.

Liquid crystal cell 60 may be used in combination with linear polarizer 72, geometric phase grating 56 and quarter wave plate 58 to operate display 14 in different modes.

While operating in the high resolution operating mode, liquid crystal cell 60 may switch between two states. While the liquid crystal cell is in the first state, each physical pixel may have a first associated apparent pixel location that is shifted relative to the actual pixel location. While the liquid crystal cell is in the second state, each pixel may have a second associated apparent pixel location that is shifted relative to the actual pixel location. The first and second apparent pixel locations are different. By synchronizing the operation of the pixel with the switching of liquid crystal cell 60 between the first and second states, the display may display different content at the first and second apparent pixel locations. This effectively doubles the apparent resolution of the display relative to the native resolution of display panel 14P.

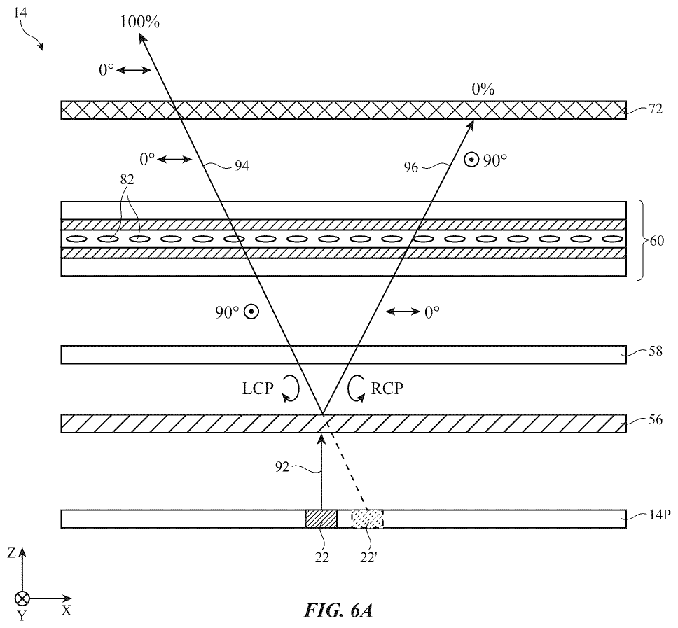

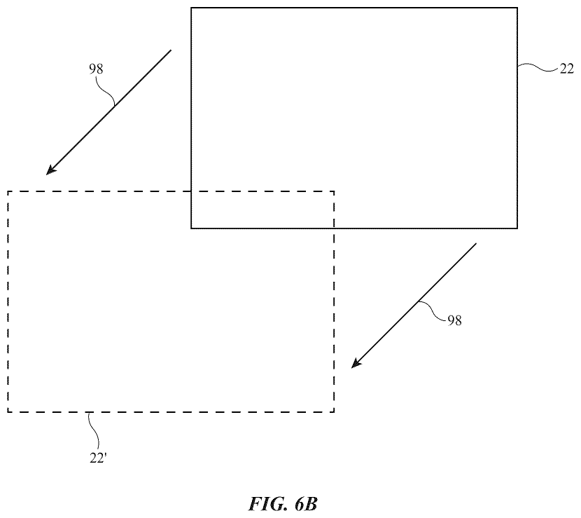

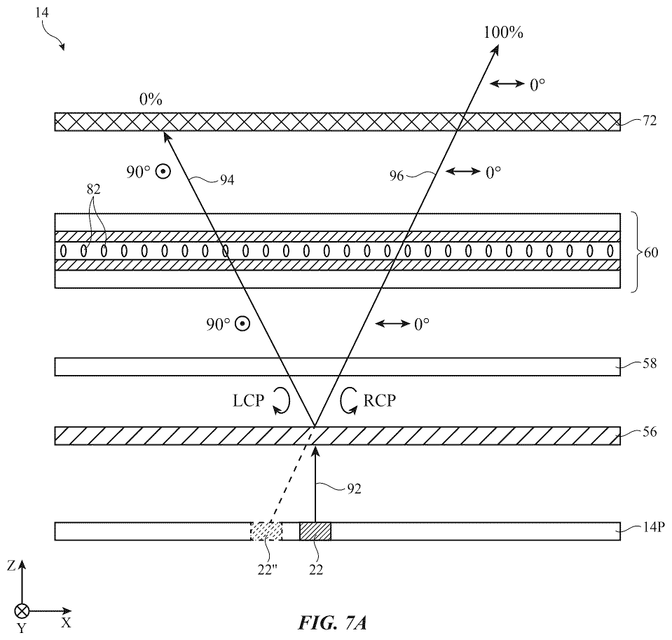

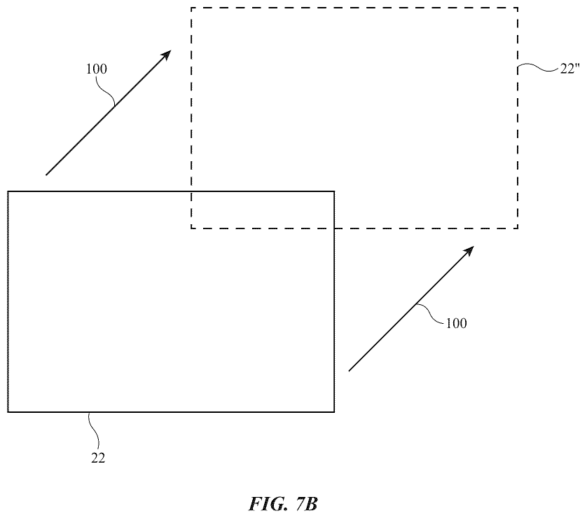

FIG. 6A is a schematic diagram of display 14 when liquid crystal cell 60 is in the first state and FIG. 7A is a schematic diagram of display 14 when liquid crystal cell 60 is in the second state. As shown in FIG. 6A, a given pixel 22 may emit light in the positive Z-direction. The emitted light 92 may be split into two output beams having opposite circular polarization by light redirecting layer 56 (similar to as shown and discussed in connection with FIG. 5). A first output beam 94 has lefthand circular polarization and is redirected in the negative X-direction by light redirecting layer 56. A second output beam 96 has righthand circular polarization and is redirected in the positive X-direction by light redirecting layer 56.

Each one of output beams 94 and 96 may subsequently pass through quarter wave plate 58 and liquid crystal cell 60 (in that order) after exiting light redirecting layer 56. Quarter wave plate 58 converts the circular polarization of the incident light into a linear polarization. As shown in FIG. 6A, the lefthand circularly polarized light of beam 94 exits quarter wave plate 58 with a linear polarization aligned with a 90 degree axis. The righthand circularly polarized light of beam 96 exits quarter wave plate 58 with a linear polarization aligned with a 0 degree axis.

Liquid crystal cell 60 may selectively modify the polarization of incident light based on the state of the liquid crystal cell. In FIG. 6A, liquid crystal cell 60 acts as a polarization rotator that changes the polarization of incident linearly polarized light by 90 degrees. As shown, beam 94 enters liquid crystal cell 60 with a linear polarization aligned with a 90 degree axis and exits liquid crystal cell 60 with an orthogonal linear polarization aligned with a 0 degree axis. Beam 96 enters liquid crystal cell 60 with a linear polarization aligned with a 0 degree axis and exits liquid crystal cell 60 with an orthogonal linear polarization aligned with a 90 degree axis.

Linear polarizer 72 may pass light of a first linear polarization and block light of a second, orthogonal linear polarization. In the example of FIG. 6A, linear polarizer 72 passes light with a linear polarization along a 0 degree axis and blocks light with a linear polarization along a 90 degree axis. Accordingly, 100% (or near 100% such as greater than 90%, greater than 95%, etc.) of beam 94 passes through the linear polarizer whereas 0% (or near 0% such as less than 10%, less than 5%, etc.) of beam 96 passes through the linear polarizer.

To summarize, approximately all of beam 94 output by light redirecting layer 56 eventually passes through linear polarizer 72 for viewing by the user whereas approximately none of beam 96 output by light redirecting layer 56 eventually passes through linear polarizer 72 for viewing by the user. As a result of this configuration, the light emitted by pixel 22 will have an apparent pixel location 22′ that is shifted relative to the actual pixel location on display panel 14P.

FIG. 6B is a top view of pixel 22 when display 14 has the configuration of FIG. 6A. As shown in FIG. 6B, the pixel 22 may have a footprint at a first location on display panel 14P. However, when the display has the configuration of FIG. 6A, the apparent pixel location 22′ is shifted in direction 98 relative to the physical pixel location. Pixel 22 may sometimes be referred to as a physical pixel and apparent pixel location 22′ may sometimes be referred to as virtual pixel 22′.

The magnitude of the shift between physical pixel 22 and virtual pixel 22′ may be less than a width and/or length of the footprint of physical pixel 22, may be greater than the width and/or length of the footprint of physical pixel 22, may be within 50% the width and/or length of the footprint of physical pixel 22, may be within 75% the width and/or length of the footprint of physical pixel 22, etc.

In FIG. 6A, liquid crystals 82 are elongated parallel to the X-axis. In this configuration, liquid crystal cell 60 rotates the polarization of incident light by 90 degrees. As shown in FIG. 7A, display 14 may be operable in another configuration in which liquid crystals 82 are elongated parallel to the Z-axis. In this configuration, liquid crystal cell 60 does not rotate the polarization of incident light.

As shown in FIG. 7A, a given pixel 22 may emit light in the positive Z-direction. The emitted light 92 may be split into two output beams having opposite circular polarization by light redirecting layer 56 (similar to as shown and discussed in connection with FIG. 5). A first output beam 94 has lefthand circular polarization and is redirected in the negative X-direction by light redirecting layer 56. A second output beam 96 has righthand circular polarization and is redirected in the positive X-direction by light redirecting layer 56.

Each one of output beams 94 and 96 may subsequently pass through quarter wave plate 58 and liquid crystal cell 60 (in that order) after exiting light redirecting layer 56. Quarter wave plate 58 converts the circular polarization of the incident light into a linear polarization. As shown in FIG. 7A, the lefthand circularly polarized light of beam 94 exits quarter wave plate 58 with a linear polarization aligned with a 90 degree axis. The righthand circularly polarized light of beam 96 exits quarter wave plate 58 with a linear polarization aligned with a 0 degree axis.

Liquid crystal cell 60 may selectively modify the polarization of incident light based on the state of the liquid crystal cell. In FIG. 7A, the liquid crystal cell 60 does not change the polarization of incident linearly polarized light. As shown, beam 94 enters liquid crystal cell 60 with a linear polarization aligned with a 90 degree axis and exits liquid crystal cell 60 with the same linear polarization (aligned with a 90 degree axis). Beam 96 enters liquid crystal cell 60 with a linear polarization aligned with a 0 degree axis and exits liquid crystal cell 60 with the same linear polarization (aligned with a 0 degree axis).

Linear polarizer 72 may pass light of a first linear polarization and block light of a second, orthogonal linear polarization. In the example of FIG. 7A, linear polarizer 72 passes light with a linear polarization along a 0 degree axis and blocks light with a linear polarization along a 90 degree axis. Accordingly, 100% (or near 100% such as greater than 90%, greater than 95%, etc.) of beam 96 passes through the linear polarizer whereas 0% (or near 0% such as less than 10%, less than 5%, etc.) of beam 94 passes through the linear polarizer.

To summarize, approximately all of beam 96 output by light redirecting layer 56 eventually passes through linear polarizer 72 for viewing by the user whereas approximately none of beam 94 output by light redirecting layer 56 eventually passes through linear polarizer 72 for viewing by the user. As a result of this configuration, the light emitted by pixel 22 will have an apparent pixel location 22″ that is shifted relative to the actual pixel location on display panel 14P.

FIG. 7B is a top view of pixel 22 when display 14 has the configuration of FIG. 7A. As shown in FIG. 7B, the pixel 22 may have a footprint at a first location on display panel 14P. However, when the display has the configuration of FIG. 7A, the apparent pixel location 22″ is shifted in direction 100 relative to the physical pixel location. Pixel 22 may sometimes be referred to as a physical pixel and apparent pixel location 22″ may sometimes be referred to as virtual pixel 22″.

The magnitude of the shift between physical pixel 22 and virtual pixel 22″ may be less than a width and/or length of the footprint of physical pixel 22, may be greater than the width and/or length of the footprint of physical pixel 22, may be within 50% the width and/or length of the footprint of physical pixel 22, may be within 75% the width and/or length of the footprint of physical pixel 22, etc.

In the high resolution operating mode, display pixel 22 may switch between first and second luminance values during each frame. Liquid crystal cell 60 may also switch between the configuration of FIG. 6A and the configuration of FIG. 7A during each frame. The switch between the luminance values of the display pixel is synchronized with the switch between configurations of FIGS. 6A and 7A of liquid crystal cell 60. With this arrangement, a single physical pixel has two associated virtual pixels with independently controllable luminance in each frame. The effective resolution of the display in the high resolution operating mode is double the native resolution of the pixels in display panel 14P (because each physical pixel controls two virtual pixels per frame).

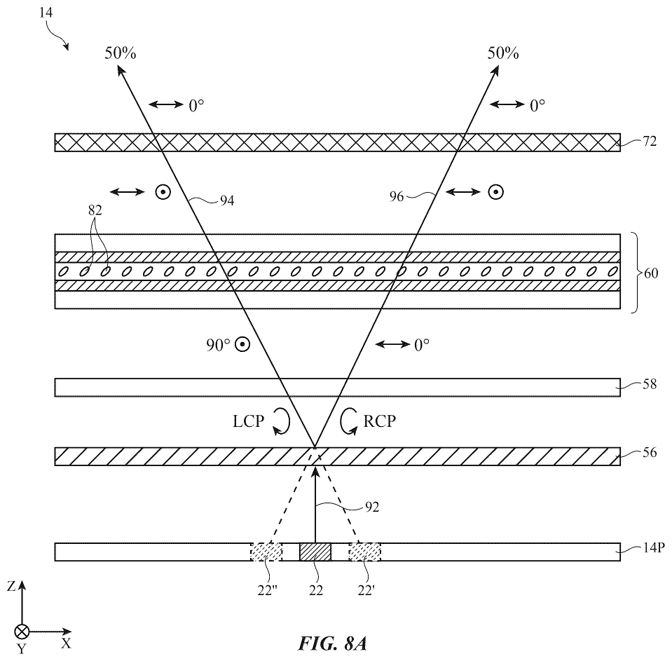

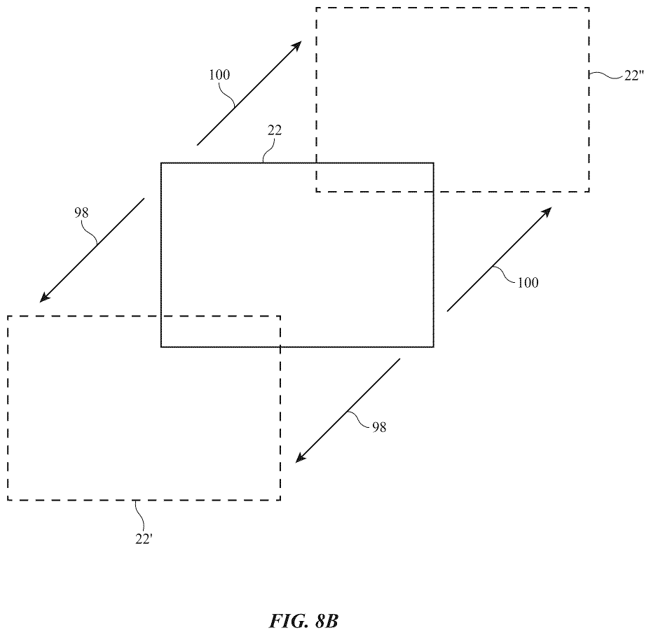

FIG. 8A is a schematic diagram of display 14 when the display operates in the high refresh rate operating mode. In FIG. 8A, the liquid crystal cell has is placed in a third state where liquid crystals 82 are elongated at a 45 degree angle relative between the X-axis and the Z-axis. In this configuration, liquid crystal cell 60 rotates the polarization of incident light by 45 degrees.

As shown in FIG. 8A, a given pixel 22 may emit light in the positive Z-direction. The emitted light 92 may be split into two output beams having opposite circular polarization by light redirecting layer 56 (similar to as shown and discussed in connection with FIG. 5). A first output beam 94 has lefthand circular polarization and is redirected in the negative X-direction by light redirecting layer 56. A second output beam 96 has righthand circular polarization and is redirected in the positive X-direction by light redirecting layer 56.

Each one of output beams 94 and 96 may subsequently pass through quarter wave plate 58 and liquid crystal cell 60 (in that order) after exiting light redirecting layer 56. Quarter wave plate 58 converts the circular polarization of the incident light into a linear polarization. As shown in FIG. 8A, the lefthand circularly polarized light of beam 94 exits quarter wave plate 58 with a linear polarization aligned with a 90 degree axis. The righthand circularly polarized light of beam 96 exits quarter wave plate 58 with a linear polarization aligned with a 0 degree axis.

Liquid crystal cell 60 may selectively modify the polarization of incident light based on the state of the liquid crystal cell. In FIG. 8A, the liquid crystal cell 60 rotates the polarization of incident light by 45 degrees. As shown, beam 94 enters liquid crystal cell 60 with a linear polarization aligned with a 90 degree axis and exits liquid crystal cell 60 with an equal mix of light having a linear polarization aligned with a 90 degree axis and light having a linear polarization aligned with a 0 degree axis. Beam 96 enters liquid crystal cell 60 with a linear polarization aligned with a 0 degree axis and exits liquid crystal cell 60 with an equal mix of light having a linear polarization aligned with a 90 degree axis and light having a linear polarization aligned with a 0 degree axis.

Linear polarizer 72 may pass light of a first linear polarization and block light of a second, orthogonal linear polarization. In the example of FIG. 8A, linear polarizer 72 passes light with a linear polarization along a 0 degree axis and blocks light with a linear polarization along a 90 degree axis. Accordingly, 50% (or near 50% such as between 40% and 60%, between 45% and 55%, etc.) of beam 94 passes through the linear polarizer and 50% (or near 50% such as between 40% and 60%, between 45% and 55%, etc.) of beam 96 passes through the linear polarizer.

To summarize, approximately half of beam 94 output by light redirecting layer 56 eventually passes through linear polarizer 72 for viewing by the user and approximately half of beam 96 output by light redirecting layer 56 eventually passes through linear polarizer 72 for viewing by the user. As a result of this configuration, the light emitted by pixel 22 will have a first apparent pixel location 22′ that is shifted relative to the actual pixel location on display panel 14P and a second apparent pixel location 22″ that is shifted relative to the actual pixel location on display panel 14P.

FIG. 8B is a top view of pixel 22 when display 14 has the configuration of FIG. 8A. As shown in FIG. 8B, the pixel 22 may have a footprint at a first location on display panel 14P. However, when the display has the configuration of FIG. 8A, there are first and second apparent pixel locations 22′ and 22″ shifted relative to the physical pixel location.

In the high refresh rate operating mode, a single physical pixel 22 is simultaneously viewable at first and second apparent pixel locations 22′ and 22″. Accordingly, the effective resolution of the display in the high refresh rate operating mode is equal to the native pixel resolution of display panel 14P. The effective resolution of the display in the high refresh rate operating mode is therefore half the effective resolution of the display in the high resolution operating mode. However, the refresh rate in the high refresh rate operating mode is double the refresh rate in the high resolution operating mode.

It is noted that the position of quarter wave plate 58 between geometric phase grating 56 and liquid crystal cell 60 in FIGS. 3, 6A, 7A, and 8A is merely illustrative. The quarter wave plate 58 may instead be interposed between liquid crystal cell 60 and linear polarizer 72 if desired.

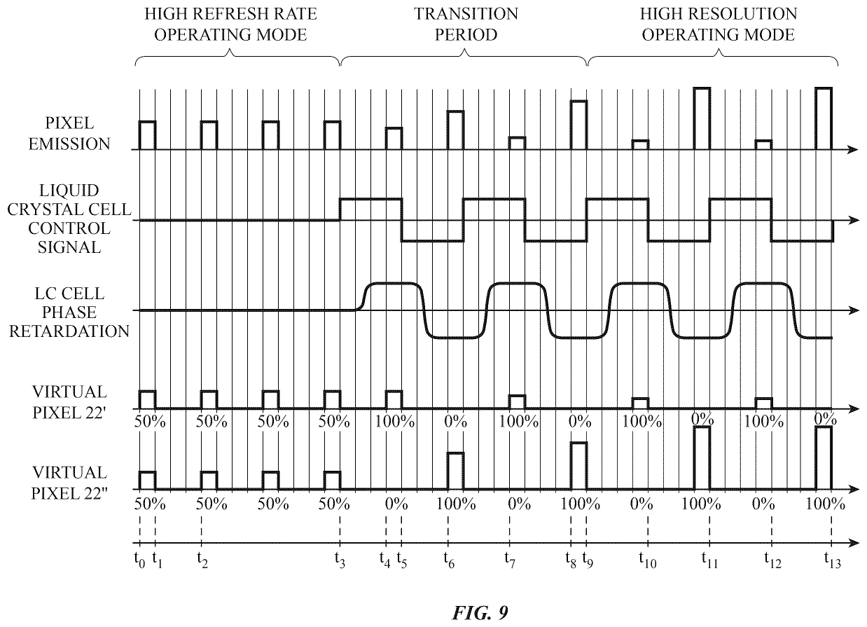

FIG. 9 is a timing diagram showing operation of display 14 in different operating modes. The first subset of the timing diagram shows pixel emission (e.g., pixel luminance) for a given physical pixel 22. The second subset of the timing diagram shows a control signal for liquid crystal cell 60 (e.g., the voltage applied across electrodes 64 and 68 of liquid crystal cell 60). The third subset of the timing diagram shows the phase retardation provided by liquid crystal cell 60. The fourth subset of the timing diagram shows the luminance of virtual pixel 22′ associated with physical pixel 22. The fifth subset of the timing diagram shows the luminance of virtual pixel 22″ associated with physical pixel 22.

FIG. 9 shows the display during a high refresh rate operating mode (between to and t₃), during a transition period (between t₃ and t₉), and during a high resolution operating mode (between t₀ and t₁₃).

The physical pixels 22 may operate with a duty cycle. In the example of FIG. 9, the pixels operate with a 25% duty cycle. This means that the pixel emits light for 25% of each frame. As shown in FIG. 9, the first frame may have a first duration between to and t₂. The given physical pixel may have a non-zero emission during a second duration between t₀ and t₁. The second duration (between t₀ and t₁) may be equal to 25% of the first duration (between to and t₂). This 25% duty cycle pattern may continue, with pixel 22 emitting light for 25% of each frame.

The example of the duty cycle being 25% is merely illustrative and in general each pixel may have any desired duty cycle (e.g., 33%, 25%, less than 50%, less than 30%, less than 20%, etc.).

In the high refresh rate operating mode, the pixel may have a given luminance. Throughout the high refresh rate operating mode, the display has the configuration of FIG. 8A. Accordingly, the liquid crystal cell control signal is at an intermediate value that provides an intermediate magnitude of phase retardation between to and t₃. When the pixel emits light (e.g., during the on portion of the duty cycle), both virtual pixels 22′ and 22″ have a luminance that is 50% the luminance of physical pixel 22. The luminance of pixel 22 (and therefore virtual pixels 22′ and 22″) may be changed in different frames if desired. The duration of each frame during the high refresh rate is equal to the first duration (between to and t₂). As one example, the first duration (between to and t₂) is equal to 8.33 milliseconds and the display operates with a refresh rate of 120 Hz during the high refresh rate operating mode.

In the high resolution operating mode, the liquid crystal cell control signal repeatedly switches between a high voltage (associated with the high level of phase retardation) and a low voltage (associated with the low or zero level of phase retardation). As shown in FIG. 9, the control signal may be at the high level between t₀ and t₁₀, the low level between t₁₀ and t₁₁, the high level between t₁₁ and t₁₂, and the low level between t₁₂ and t₁₃.

The liquid crystal cell control signal may switch between the high and low levels immediately after pixel emission concludes. For example, the pixel emission between t₈ and t₉ concludes at to. At t₉, the liquid crystal control signal switches from the low level to the high level. Between t₈ and t₉, the liquid crystal cell phase retardation may be at a low (zero) level associated with the low level of the control signal. At t₉, after the liquid crystal control signal switches from the low level to the high level, the phase retardation may gradually increase to the high level. Switching the liquid crystal control signal immediately after a given pixel emission period concludes may ensure that the phase retardation of the liquid crystal has fully transitioned to a target level before the next pixel emission begins.

In the high resolution operating mode, each frame may have a given duration. FIG. 9 shows a first frame between t₉ and t₁₁ and a second frame between t₁₁ and t₁₃. As one example, the given duration is equal to 16.66 milliseconds and the display operates with a refresh rate of 60 Hz during the high resolution operating mode.

When the liquid crystal phase retardation is high (as controlled by a high liquid crystal cell control signal), the display may have the arrangement of FIG. 6A. When the liquid crystal phase retardation is low (as controlled by a low liquid crystal cell control signal), the display may have the arrangement of FIG. 7A. Consider the frame between t₀ and t₁. At t₉, the liquid crystal cell control signal is switched to the high state and the liquid crystal phase retardation gradually transitions to a high level. While the liquid crystal phase retardation is at the high level (and the display has the arrangement of FIG. 6A), there may be a first pixel emission for the frame. The first pixel emission will be 100% (or near 100%) visible at virtual pixel location 22′ (and 0% or near 0% visible at virtual pixel location 22″). At t₁₀, the liquid crystal cell control signal is switched to the low state and the liquid crystal phase retardation gradually transitions to a low level. While the liquid crystal phase retardation is at the low level (and the display has the arrangement of FIG. 7A), there may be a second pixel emission for the frame. The second pixel emission will be 100% (or near 100%) visible at virtual pixel location 22″ (and 0% or near 0% visible at virtual pixel location 22′). FIG. 9 shows an example where the luminance of virtual pixel 22″ is greater than the luminance of virtual pixel 22′. In general, the luminance of virtual pixel 22″ may be selected to be greater than, equal to, or less than the luminance of virtual pixel 22′.

There may optionally be a transition period between the high refresh rate operating mode and the high resolution operating mode. During the transition period, the display may operate in a similar manner to as in the high resolution operating mode. As shown in FIG. 9, the liquid crystal cell control signal and corresponding liquid crystal cell phase retardation follows the same pattern in the transition period as in the high resolution operating mode.

To avoid visible artifacts when switching between the operating modes, the pixel luminance may transition gradually during the transition period. During the high refresh rate operating mode, virtual pixels 22′ and 22″ have an equal, medium luminance. During the high resolution operating mode, virtual pixel 22″ has a high luminance whereas virtual pixel 22′ has a low luminance. During the transition period, the luminance of virtual pixel 22′ may gradually transition away from the medium luminance towards the low luminance. Simultaneously, the luminance of virtual pixel 22″ may gradually transition away from the medium luminance towards the high luminance.

As shown in FIG. 9, virtual pixel 22′ has a luminance at t₄ that is less than the luminance of virtual pixel 22′ during the high refresh rate operating mode but greater than the luminance of virtual pixel 22′ during the high resolution operating mode. Virtual pixel 22′ has a luminance at t₇ that is less than the luminance of virtual pixel 22′ at t₄ but greater than the luminance of virtual pixel 22′ during the high resolution operating mode. There are therefore two intermediate luminance magnitudes for virtual pixel 22′ during the transition period.

As shown in FIG. 9, virtual pixel 22″ has a luminance at to that is greater than the luminance of virtual pixel 22″ during the high refresh rate operating mode but less than the luminance of virtual pixel 22″ during the high resolution operating mode. Virtual pixel 22″ has a luminance at t₈ that is greater than the luminance of virtual pixel 22″ at t₆ but less than the luminance of virtual pixel 22″ during the high resolution operating mode. There are therefore two intermediate luminance magnitudes for virtual pixel 22″ during the transition period.

The example in FIG. 9 of the transition period including two frames at 60 Hz is merely illustrative. In general, the transition period may include any desired number of frames.

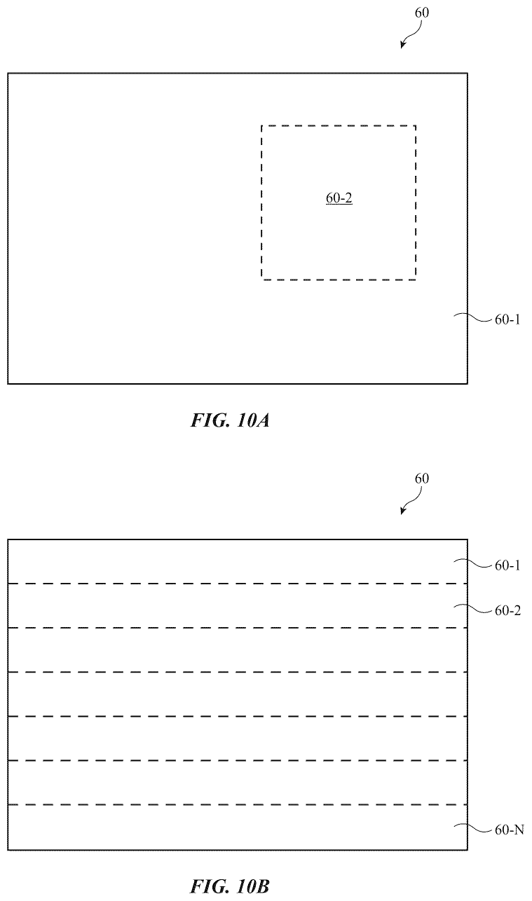

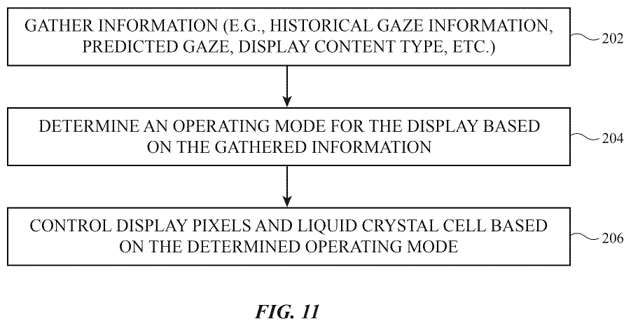

In the example of FIG. 3, liquid crystal cell 60 is controlled globally. The liquid crystal cell is in the same state across the entire footprint of display 14. Accordingly, the entire display operates in the same operating mode at any given point in time. This example is merely illustrative. FIG. 10A is a top view of a liquid crystal cell that is patterned with two or more independently controllable areas. As shown in FIG. 10A, liquid crystal cell 60 has a first portion 60-1 and a second portion 60-2. The electrodes in the liquid crystal cell may be patterned such that portions 60-1 and 60-2 may be independently controlled. Electrodes 64 and 68 may each have first and second electrically isolated portions in portions 60-1 and 60-2 respectively. This allows for portions 60-1 and 60-2 of liquid crystal cell 60 to operate in different states. Different portions of display 14 may therefore operate in different operating modes at the same time if desired.

As shown in FIG. 10A, portion 60-2 may be completely laterally surrounded by portion 60-1. Portion 60-2 may tend to align with a center of the user's field of view when the user views display 60 whereas portion 60-1 may tend to align with a periphery of the user's field of view when the user views display 60. Portion 60-2 may tend to operate in the high resolution operating mode (because the center of the user's field of view is more sensitive to resolution than refresh rate) whereas portion 60-1 may tend to operate in the high refresh rate operating mode (because the periphery of the user's field of view is more sensitive to refresh rate than resolution).

In another possible arrangement, shown in FIG. 10B, liquid crystal cell 60 has a plurality of individually controllable portions that extend laterally across the display. A first portion 60-1 is formed at the top of the display extending in a strip across the entire display. A first portion 60-2 is formed below portion 60-1 extending in a strip across the entire display. This pattern may continue for N discrete portions of liquid crystal cell 60. The number N may be greater than or equal to 2, greater than or equal to 4, greater than or equal to 8, greater than or equal to 16, greater than or equal to 32, greater than or equal to 64, etc. Each electrode portion may be independently controlled. Electrodes 64 and 68 may each have first and second electrically isolated portions in each one of portions 60-1 through 60-N respectively. This allows for the discrete portions of liquid crystal cell 60 to operate in different states. Different portions of display 14 may therefore operate in different operating modes at the same time if desired. With the arrangement of FIG. 10B, the horizontal segments of liquid crystal cell 60 may be used to provide a rolling emission profile for the display.

FIG. 11 is a flowchart of an illustrative method for controlling the operating mode of display 14. During the operations of block 202, control circuitry 16 may gather information. In particular, control circuitry 16 may gather information from eye and/or head tracking system 18 such as historical gaze information. The historical gaze information may include the user's direction of gaze for a previous duration of time (e.g., the user's point of gaze for the previous 2 seconds, for the previous 1 second, for the previous 0.5 seconds, etc.). Control circuitry 16 may optionally use the historical gaze information and/or other input to predict the user's gaze behavior (e.g., is a user likely to be moving their direction of gaze).

In addition to gaze information, control circuitry 16 may gather information regarding the type of content being presented by display 14. In particular, control circuitry 16 may determine whether the type of content being presented by display 14 comprises static content or moving content (e.g., video content).

Next, during the operations of block 204, control circuitry 16 may determine an operating mode for display 14 based on the gathered information from block 202. As examples, control circuitry 16 may determine that display 14 should operate in a high refresh rate operating mode when the gathered information indicates that video content is being presented by display 14. When the gathered information indicates that static content is being presented by display 14, control circuitry 16 may determine that display 14 should operate in the high refresh rate operating mode when the historical gaze information and/or predicted gaze indicates the user's direction of gaze is likely changing or about to change. When the gathered information indicates that static content is being presented by display 14, control circuitry 16 may determine that display 14 should operate in the high resolution operating mode when the historical gaze information and/or predicted gaze indicates the user's direction of gaze is likely not changing and not about to change. Display 14 may optionally operate in the high resolution operating mode even if some or all of the content is moving or expected to move.

It is noted that in embodiments where the liquid crystal cell has multiple independently controllable areas, the control circuitry may determine an operating mode for each discrete portion of the display during the operations of block 204.

During the operations of block 206, control circuitry 16 may control pixels 22 and liquid crystal cell 60 based on the determined operating mode. When the display operates in the high refresh rate operating mode, control circuitry 16 may apply an intermediate voltage to the electrodes of liquid crystal cell 60 (as in FIG. 8A). When the display operates in the high refresh rate operating mode, the display may have a first effective resolution (RS1) and a first effective refresh rate (RR1).

When the display operates in the high resolution operating mode, control circuitry 16 may switch between applying a high voltage to the electrodes of liquid crystal cell 60 (as in FIG. 6A) and applying a low voltage (or no voltage) to the electrodes of liquid crystal cell 60 (as in FIG. 7A) once during each frame. During each frame, each pixel 22 may first emit light at a first luminance magnitude while the high voltage is applied to the electrodes of liquid crystal cell 60 and may then subsequently emit light at a second luminance magnitude (that is different than the first luminance magnitude) while the low voltage is applied to the electrodes of liquid crystal cell 60. When the display operates in the high resolution operating mode, the display may have a second effective resolution (RS2) that is double the first effective resolution (e.g., RS2=2*RS1) and a second effective refresh rate (RR2) that is half the first effective refresh rate (e.g., RR2=RR1/2).

The example of display 14 being included in an electronic device with one or more lens elements is merely illustrative. The lens assembly 42 may be omitted from electronic device 10 if desired.

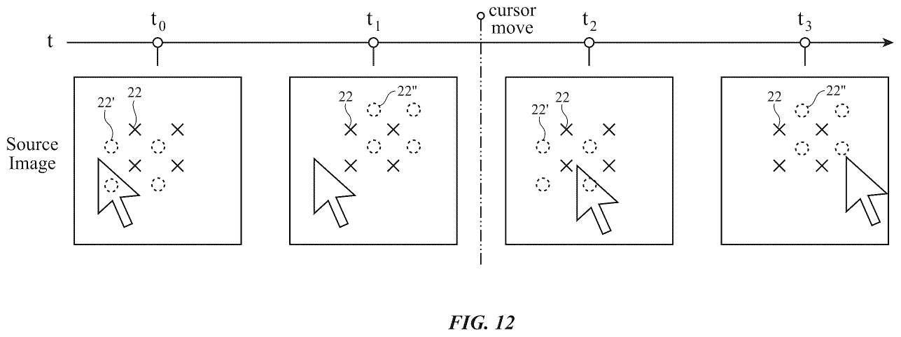

When display 14 operates in the high resolution operating mode, spatial and temporal sampling may be performed to obtain image data for each physical pixel in each frame. FIG. 12 is a diagram illustrating spatial and temporal sampling for the frames (sometimes referred to as display frames). FIG. 12 shows four images that are sampled for four consecutive frames. The first frame is sampled at time t₀, the second frame is sampled at time t₁, the third frame is sampled at time t₂, and the fourth frame is sampled at time t₃. The content on display 14 may be primarily static and the historical gaze information and/or predicted gaze may indicate the user's direction of gaze is likely not changing and not about to change. Display 14 may therefore operate in the high resolution operating mode where the liquid crystal cell switches between first and second states. Display 14 may also operate in the high resolution operating mode even if some or all of the content is moving or expected to move.

In FIG. 12, the frames at to and t₂ are associated with the first state for the liquid crystal cell (e.g., as shown in FIGS. 6A and 6B) and the frames at t₁ and t₃ are associated with the second state for the liquid crystal cell (e.g., as shown in FIGS. 7A and 7B). FIG. 12 shows a source image for each one of the four frames at t₀, t₁, t₂, and t₃. Four physical pixels 22 are marked by X's in each source image. The position of the physical pixels is constant between frames. Four virtual pixel locations are also marked by circles in each source image. In the frames at to and t₂, the virtual pixels 22′ are shifted in a first direction relative to the physical pixels. In the frames at t₁ and t₃, the virtual pixels 22″ are shifted in a second, opposite direction relative to the physical pixels. The data displayed at the physical pixels in the frames at to and t₂ (associated with the first state for the liquid crystal cell) may therefore be obtained using sampling at the locations of virtual pixels 22′. The data displayed at the physical pixels in the frames at t₁ and t₃ (associated with the second state for the liquid crystal cell) may therefore be obtained using sampling at the locations of virtual pixels 22″. This pattern may be repeated for future image frames while the display is in the high resolution operating mode.

FIG. 12 shows an example where at least some content moves across the display while the display is in the high resolution operating mode. Between t₁ and t₂, a cursor may begin to move to the right. The cursor is shifted in the frame at t₂ relative to the frames at t₀ and t₁. The cursor is shifted in the frame at t₃ relative to the frame at t₂. If care is not taken, content that moves while the display is in the high resolution operating mode (such as the moving cursor of FIG. 12) may suffer from a shimmering artifact. The shimmering artifact may be most prevalent when the speed of the motion of the content (sometimes referred to as the content velocity) in a given direction is such that the difference in the phase in motion between the even frames and the odd frames is equal to (or close to) an integer.

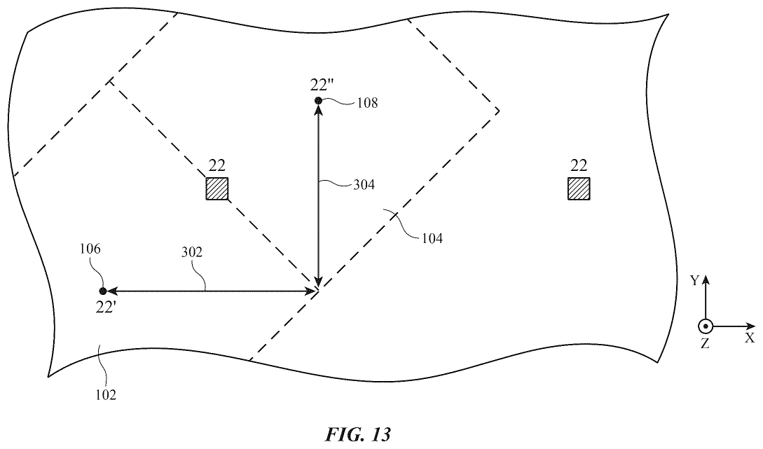

FIG. 13 is a top view of an illustrative display showing how sampling may be performed for frames in the high resolution operating mode. For physical pixel 22 in FIG. 13, half of the frames (associated with FIGS. 6A and 6B and pixel location 22′) may be sampled using a first subset 102 of the source image. The first subset 102 may be centered on the virtual pixel location 22′. The center of the first subset may be referred to as sampling point 106. In FIG. 13, sampling point 106 is aligned with virtual pixel location 22′. The remaining half of the frames (associated with FIGS. 7A and 7B and pixel location 22″) may be sampled using a second subset 104 of the source image. The second subset 104 may be centered on the virtual pixel location 22″. The center of the second subset may be referred to as sampling point 108. In FIG. 13, sampling point 108 is aligned with virtual pixel location 22″.

The displacement between sampling points 106 and 108 may have a baseline that is used when no motion is present in the content on display 14. At the baseline, sampling point 106 is aligned with virtual pixel location 22′ and sampling point 108 is aligned with virtual pixel location 22″. In the example of FIG. 13, there is a displacement 302 in the X-direction and a displacement 304 in the Y-direction. The magnitudes of displacements 302 and 304 are equal in the baseline configuration. The magnitude of displacement 302 may be equal to half of the distance between physical pixels 22 adjacent in the X-direction. In other words, in the baseline configuration displacement 302 is equal to 0.5 the physical pixel pitch in the X-direction. The magnitude of displacement 304 may be equal to half of the distance between physical pixels 22 adjacent in the Y-direction. In other words, in the baseline configuration displacement 304 is equal to 0.5 the physical pixel pitch in the Y-direction.

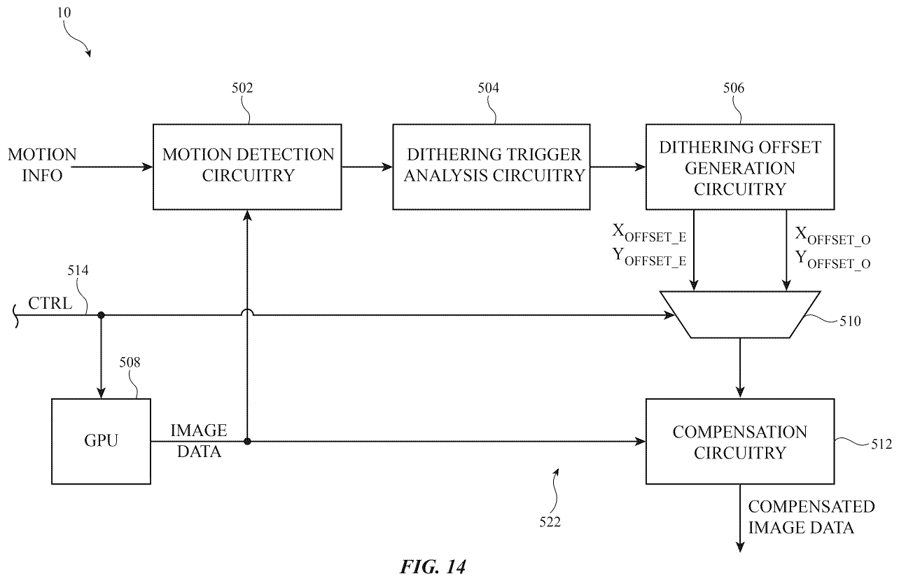

To mitigate the aforementioned shimmer artifact, the magnitude of displacement 302 and/or displacement 304 may be dithered by control circuitry 16. FIG. 14 is a diagram of illustrative control circuitry that performs dithering to mitigate the shimmer artifact. As shown in FIG. 14, control circuitry 16 may include motion detection circuitry 502, dithering trigger analysis circuitry 504, dither offset generation circuitry 506, a multiplexer 510, compensation circuitry 512, and a graphics processing unit (GPU) 508. Motion detection circuitry 502, dithering trigger analysis circuitry 504, dither offset generation circuitry 506, multiplexer 510, and compensation circuitry 512 may sometimes collectively be referred to as shimmer mitigation circuitry 522, dithering circuitry 522, etc.

Motion detection circuitry 502 may be configured to determine the content velocity of any or all content on display 14. The motion detection circuitry may receive source images from GPU 508 and may determine content velocity from the source images. Instead or in addition, the motion detection circuitry may receive motion information from one or more additional components within electronic device 10.

As one example, content on display 14 may have a uniform content velocity when the content on the display is scrolled. For example, display 14 may present a web page that the user may periodically scroll. The content velocity may be determined by motion detection circuitry 502 based on information regarding the speed of the scroll (e.g., from a mouse, hand tracking information, head tracking information, gaze tracking information, etc.).

As another example, some content on display 14 may be world-locked content that has an apparent location that remains in a fixed position relative to the user's three-dimensional environment. Consider an example where electronic device 10 is a head-mounted device displaying world-locked content. If the user turns their head, the position of the world-locked content needs to move relative to display 14 to allow the position of the world-locked content to remain fixed relative to the user's three-dimensional environment. Accordingly, sensor data from one or more motion sensors that determine the user's head movement may be used to determine the content velocity by motion detection circuitry 502.

Instead or in addition, motion detection circuitry 502 may determine content velocity based on gaze detection data for the user, based on information from an application running on electronic device 10, based on outward-facing camera data (e.g., that is used for hand tracking), etc.

Motion detection circuitry 502 may determine the content velocity in the units of pixels per frame, as one example. Dithering trigger analysis circuitry 504 may determine whether the content velocity is in a range that causes undesired shimmering artifacts. As previously discussed, the shimmering artifact may be most prevalent when content velocity in a given direction is such that the difference in the phase in motion between the even frames and the odd frames is equal to (or close to) an integer. As the content velocity increases, there are varying content velocity ranges with noticeable shimmer artifact and content velocity ranges without noticeable shimmer artifact. The content velocity ranges with noticeable shimmer artifacts may be stored by dithering trigger analysis circuitry 504. When the content velocity is within a content velocity range with noticeable shimmer artifact, dithering trigger analysis circuitry may flag the frame(s) for dithering to mitigate the artifact. As one example, the content velocity ranges with noticeable shimmer artifacts stored by dithering trigger analysis circuitry 504 include 1±0.4 pixels per frame, 3±0.4 pixels per frame, 5±0.4 pixels per frame, etc.

It is noted that motion detection circuitry 502 and dithering trigger analysis circuitry 504 may independently analyze content velocity in the X-direction and content velocity in the Y-direction.

When the dither trigger analysis circuitry 504 indicates the content velocity is within a flagged range, dither offset generation circuitry 506 may output dithered offset values for the image data. Dither offset generation circuitry 506 may output two offset values for the even frames (when the physical pixel has a first virtual pixel location) and two offset values for the odd frames (when the physical pixel has a second, different virtual pixel location). As shown in FIG. 14, dither offset generation circuitry outputs, for the even frames, a first offset value (X_{OFFSET_E}) for the X-direction that is based on content velocity in the X-direction and a second offset value (Y_{OFFSET_E}) for the Y-direction that is based on content velocity in the Y-direction. Dither offset generation circuitry outputs, for the odd frames, a first offset value (X_{OFFSET_O}) for the X-direction that is based on content velocity in the X-direction and a second offset value (Y_{OFFSET_O}) for the Y-direction that is based on content velocity in the Y-direction.

Shimmer mitigation circuitry 522 may receive a control signal 514 (CTRL) that indicates whether each physical pixel has a first virtual pixel location (e.g., for the even frames) or a second virtual pixel location (e.g., for the odd frames). The control signal may be provided to multiplexer 510. When the control signal identifies an even frame with the first associated virtual pixel locations, the multiplexer provides X_{OFFSET_E} and Y_{OFFSET_E} to compensation circuitry 512. When the control signal identifies an odd frame with the second associated virtual pixel locations, the multiplexer provides X_{OFFSET_O} and Y_{OFFSET_O} to compensation circuitry 512.

Compensation circuitry 512 (sometimes referred to as a warp block) may sample a source image from GPU 508 to obtain compensated image data. The sampling locations for the sampling operation may have baseline locations (as discussed in connection with FIG. 13). The offsets from dither offset generation circuitry 506 may be applied to the baseline locations in each frame.

The offset values for the X-direction from dither offset generation circuitry may have a range between −0.5 and 0.5 pixels (where pixels is the physical pixel pitch in the X-direction). The offset values for the Y-direction from dither offset generation circuitry may have a range between −0.5 and 0.5 pixels (where pixels is the physical pixel pitch in the Y-direction). In general the offset values generated by dither offset generation circuitry 506 may be randomly chosen within the offset value range, may be based on the content velocity, may follow a predetermined spatial and/or temporal pattern, etc.

As an example, in a given frame, a first pixel may have an X_{OFFSET} equal to 0.2 and a Y OFFSET equal to 0.4. The baseline displacement that characterizes the sampling location for the first pixel may be 0.5 in the X-direction and 0.5 in the Y-direction. After compensation, therefore, the sampling location for the first pixel may be 0.7 in the X-direction and 0.9 in the Y-direction. In other words, displacement 302 is equal to 0.7 and displacement 304 is equal to 0.9. In the given frame, a second pixel may have an X_{OFFSET} equal to 0.1 and a Y_{OFFSET} equal to 0.1. After compensation, therefore, the sampling location for the second pixel may be 0.6 in the X-direction and 0.6 in the Y-direction. In other words, displacement 302 is equal to 0.6 and displacement 304 is equal to 0.6. In the given frame, a third pixel may have an X_{OFFSET} equal to −0.4 and a Y_{OFFSET} equal to −0.1. After compensation, therefore, the sampling location for the second pixel may be 0.1 in the X-direction and 0.4 in the Y-direction. In other words, displacement 302 is equal to 0.1 and displacement 304 is equal to 0.4. In a second frame subsequent to the given frame, the offset value for each pixel may be 0. In a third frame subsequent to the second frame, displacement 302 is equal to 0.5 and displacement 304 is equal to 0.8 for the first pixel, displacement 302 is equal to 0.3 and displacement 304 is equal to 0.3 for the second pixel, and displacement 302 is equal to 0.8 and displacement 304 is equal to 0.9 for the third pixel.

After sampling is performed by compensation circuitry 512, the compensated image data may be provided to downstream display circuitry (e.g., display driver circuitry 20 from FIG. 2) for presentation on display 14.

The foregoing is merely illustrative and various modifications can be made by those skilled in the art without departing from the scope and spirit of the described embodiments. The foregoing embodiments may be implemented individually or in any combination.

What is claimed is:

1. An electronic device, comprising:
a display; and
one or more lens elements through which the display is viewable, wherein the display comprises:
a display panel comprising an array of display pixels;
a liquid crystal cell configured to selectively rotate a polarization of incident light; and
a geometric phase grating interposed between the display panel and the liquid crystal cell, wherein the display is operable in a first operating mode where the display has a first resolution and a first refresh rate, wherein the display is operable in a second operating mode where the display has a second resolution and a second refresh rate, wherein the second resolution is double the first resolution, and wherein the second refresh rate is half the first refresh rate.

2. The electronic device defined in claim 1, wherein the display further comprises:
a quarter wave plate that is interposed between the geometric phase grating and the liquid crystal cell.

3. The electronic device defined in claim 2, wherein the display further comprises:
a linear polarizer, wherein the liquid crystal cell is interposed between the quarter wave plate and the linear polarizer.

4. The electronic device defined in claim 1, wherein each display pixel in the array of display pixels has an actual pixel location, a first apparent pixel location that is shifted in a first direction relative to the actual pixel location, and a second apparent pixel location that is shifted in a second direction relative to the actual pixel location and wherein the second direction is different than the first direction.

5. The electronic device defined in claim 4, wherein the liquid crystal cell is operable in first, second, and third states, wherein light from each display pixel in the array of display pixels is visible at only the first apparent pixel location while the liquid crystal cell operates in the first state, wherein light from each display pixel in the array of display pixels is visible at only the second apparent pixel location while the liquid crystal cell operates in the second state, and wherein light from each display pixel in the array of display pixels is visible at both the first and second apparent pixel locations while the liquid crystal cell operates in the third state.

6. The electronic device defined in claim 1, further comprising:
an eye tracking system; and
control circuitry configured to operate the display in a selected one of the first and second operating modes based on point of gaze information from the eye tracking system.

7. The electronic device defined in claim 6, wherein the control circuitry is configured to operate the display in the selected one of the first and second operating modes based on a type of content being displayed.

8. The electronic device defined in claim 1, wherein the display is configured to switch from the first operating mode to the second operating mode in response to content on the display changing from video content to static content.

9. The electronic device defined in claim 8, wherein there is a transition period between the first operating mode and the second operating mode when the display switches from the first operating mode to the second operating mode.

10. The electronic device defined in claim 1, further comprising:
an eye tracking system, wherein the display is configured to switch from the second operating mode to the first operating mode in response to the eye tracking system identifying movement in a direction of gaze.

11. The electronic device defined in claim 1, wherein the liquid crystal cell comprises first and second electrodes and a liquid crystal layer that is interposed between the first and second electrodes.

12. The electronic device defined in claim 1, wherein, in the second operating mode, sampling locations for the array of display pixels vary between different frames based on a velocity of content on the display panel.

13. An electronic device, comprising:
a display panel comprising an array of display pixels;
a liquid crystal cell configured to selectively rotate a polarization of light from the array of display pixels;
a geometric phase grating that is interposed between the display panel and the liquid crystal cell;
a quarter wave plate that is interposed between the geometric phase grating and the liquid crystal cell; and
a linear polarizer, wherein the liquid crystal cell is interposed between the quarter wave plate and the linear polarizer.

14. The electronic device defined in claim 13, wherein the geometric phase grating is configured to, in response to receiving an input beam of light, output a first output beam of light having a first polarization and a second output beam of light having a second polarization that is opposite the first polarization, wherein the first output beam of light is redirected in a first direction relative to the input beam of light, wherein the second output beam of light is redirected in a second direction relative to the input beam of light, and wherein the second direction is different than the first direction.

15. The electronic device defined in claim 14, wherein the liquid crystal cell is operable in first, second, and third states, wherein the linear polarizer passes more than 90% of the first output beam and less than 10% of the second output beam while the liquid crystal cell operates in the first state, wherein the linear polarizer passes less than 10% of the first output beam and more than 90% of the second output beam while the liquid crystal cell operates in the second state, and wherein the linear polarizer passes between 40% and 60% of the first output beam and between 40% and 60% of the second output beam while the liquid crystal cell operates in the third state.

16. The electronic device defined in claim 13, further comprising:
encapsulation glass that is interposed between the display panel and the geometric phase grating.

17. The electronic device defined in claim 13, further comprising:
one or more lens elements, wherein the linear polarizer is interposed between the liquid crystal cell and the one or more lens elements.

18. The electronic device defined in claim 13, wherein the liquid crystal cell has first and second portions that are independently controllable.

19. A method of operating a display comprising physical pixels, wherein each physical pixel has first and second corresponding virtual pixels with different footprints and wherein the method comprises:
operating the display in a first mode, wherein, in the first mode:
the display has a first effective resolution;
the display has a first effective refresh rate; and
the first and second virtual pixels have the same luminance magnitudes for each physical pixel in the array of physical pixels; and
operating the display in a second mode, wherein, in the second mode:
the display has a second effective resolution that is double the first effective resolution;
the display has a second effective refresh rate that is half the first effective refresh rate; and
the first and second virtual pixels have different luminance magnitudes for at least some of the physical pixels.

20. The method defined in claim 19, further comprising:
switching between operating the display in the first mode and operating the display in the second mode based on a change in a type of content on the display.

21. The method defined in claim 19, further comprising:
switching between operating the display in the first mode and operating the display in the second mode based on a direction of gaze of a viewer of the display.
